(19) United States
(12) Patent Application Publication
(10) Pub. No.: US 2009/0145305 A1
(43) Pub. Date: Jun. 11, 2009

(54) Two piece food tray

(76) Inventors: James E. Johanson, Old Chatham, NY (US); Thomas M. Hocker, Troy, NY (US); Victor J. DesRosiers, Kinderhood, NY (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 12/001,135

(22) Filed: Dec. 10, 2007

(51) Int. Cl. A47J 36/24

(52) U.S. Cl. 99/353

(57) ABSTRACT

A tray is provided for retaining food stuffs or the like. The tray includes a dish portion and a rim portion. The dish includes a base portion and a sidewall portion surrounding the base portion and extending upwardly therefrom to define a retaining area. The rim includes an inner wall positioned around the perimeter of the dish sidewall. A retaining member engages the dish sidewall to the rim inner wall to removeably secure the dish to the rim.

### FIELD OF THE INVENTION

The invention relates to an apparatus for keeping food warm between the time of preparation and service.

### BACKGROUND

Warming ovens are used in the food service industry to keep food at a desired serving temperature. A known warming oven used in a fast food restaurant holds prepared food between the time of preparation and the time of serving. It is preferable that the warming oven keep the food in a ready-to-eat state. Temperatures inside the warming oven may reach levels above 180 degrees Fahrenheit. It is also desirable to regulate the humidity within the oven to ensure that the food does not become dried out or soggy.

A tray for use in such ovens to retain the prepared food must be constructed from materials that will withstand the conditions within the oven, as well as other storage and cleaning conditions. Further, because the tray will be used for food service, it is preferable that the materials and construction meet the guidelines of the National Science Foundation (NSF) for such applications.

Trays constructed of plastic are presently used because of their ease of handling and their durability. When kept in the warming oven, however, it is sometimes preferable that food be in contact with metal surfaces, such as aluminum or stainless steel, rather than plastic or other non-metal materials. Metals, however, are subject to deformation and may develop sharp edges due to normal use and wear. Further, when stored at elevated temperature conditions, metal may become hot to the touch, thereby making the tray difficult to handle.

### SUMMARY OF THE INVENTION

The present invention relates to an apparatus for keeping food warm between the time of preparation and service. Specifically, the invention relates to a tray for retaining food products in warming ovens or other environmentally controlled devices. The tray includes a dish portion and a rim portion. The dish includes a base portion adapted for supporting food products or the like. A wall portion surrounds the entirety of the base portion and extends upwardly therefrom to define a retaining area. The retaining area is closed by the base portion at the bottom end of the wall and is open away from the base portion at the upper end of the wall. The rim has an inner wall that extends generally parallel to the wall portion of the dish. The inner wall is secured around the perimeter of the dish. The rim defines a free end for use in handling the tray. A retaining member is formed on the inside surface of the inner wall of the rim and engages the outside surface of the wall of the dish portion. The retaining member removeably retains the dish portion in a fixed position within the rim portion.

In one aspect of the invention, the retaining member may take the form of an inwardly projecting ridge that engages the sidewall of the dish. The dish may also include a retaining groove on the outside surface of the wall portion, with the rim ridge engaging the dish groove in a friction fit.

### BRIEF DESCRIPTION OF THE DRAWINGS

For the purpose of illustrating the invention, there is shown in the drawings a form that is presently preferred; it being understood, that this invention is not limited to the precise arrangements and instrumentalities shown.

FIG. 1 is a perspective view of a tray according to an embodiment of the present invention.

FIG. 2 is an exploded perspective view showing the assembly of the constituent parts of the tray shown in FIG. 1.

FIG. 3 is a partial cross sectional view of the tray of FIGS. 1 and 2 showing the assembly of parts.

### DETAILED DESCRIPTION OF THE DRAWINGS

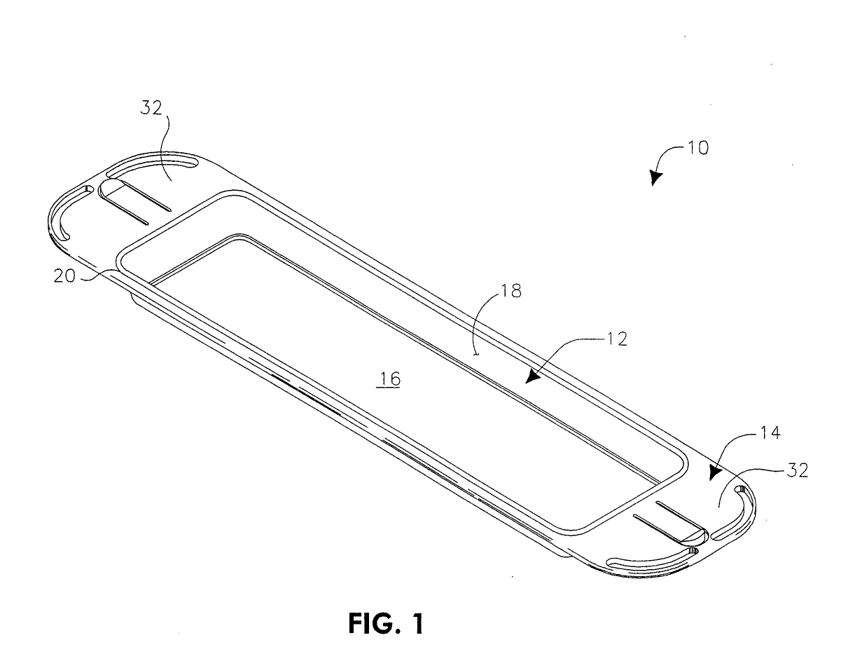

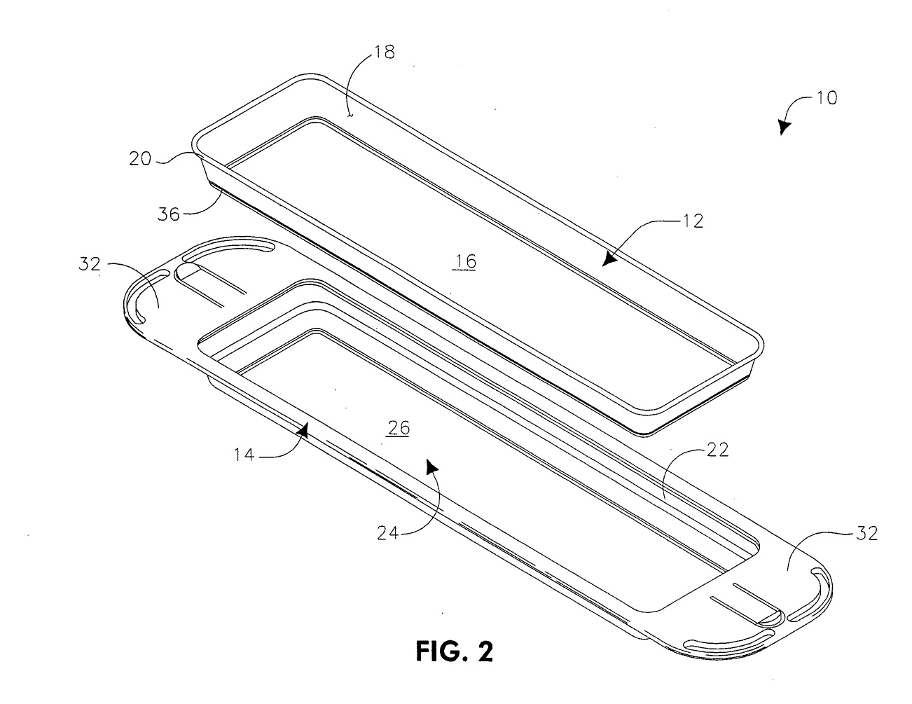

In the figures, in which like reference numerals indicate like elements, there is shown an embodiment of a tray, which is identified generally by the numeral 10. The tray is intended for use in warming ovens or the like, such as those commonly used in fast food restaurants. Preferably, the length of the tray 10 is about two feet and the width is sufficient to accommodate the food that is to be contained therein, such as a hamburger patty. The tray 10 includes a dish portion 12 and a rim portion 14. In the preferred embodiment, the dish 12 is releaseably retained by the rim 14. In FIG. 1, the dish 12 is shown retained within the rim portion 14. In FIG. 2, the dish 12 is in an exploded position, showing the particulars of the two parts.

The dish 12 includes a generally rectangular base 16 defining the bottom of the tray 10. The base 16 as illustrated is generally flat. It is contemplated that structural supports, such as raised ridges (not shown), may be formed on the bottom surface of the base 16 to allow for air flow and/or draining.

A sidewall 18 extends upwardly from the perimeter of the base 16. Together, the sidewall 18 and the base 16 define the retaining area of the dish 12. A peripheral flange 20 extends outwardly from the sidewall 18. The flange 20, sidewall 18 and base 16 are preferably of unitary construction. It is also preferable that the flange 20 extends entirely around the perimeter of the dish 12, as seen in FIGS. 1 and 2. The corners of the dish 12 may be rounded, as shown, or alternatively may be squared off, beveled or have some other desirable profile. Similarly, the joint between the base 16 and the sidewall 18 may be rounded. A rounded (or similar type) transition may also be provided between the top edge of the sidewall 18 and the flange 20.

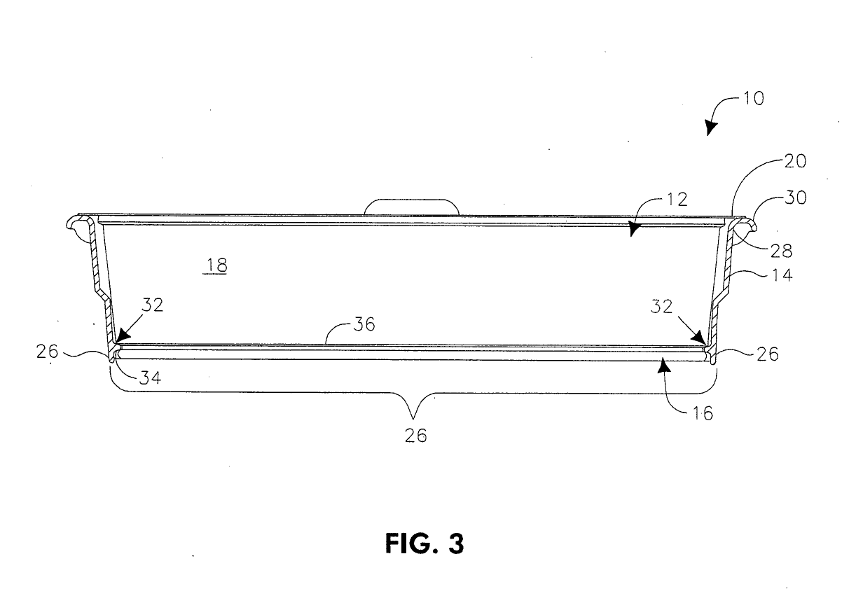

The rim 14 extends around the perimeter of the dish 12. The rim 14 comprises a substantially vertical outer wall portion 22, which defines an open volume 24 (FIG. 2). The lower portion 26 of the rim wall 22 is preferably adapted for engagement with the sidewall 18 of the dish 12 (FIG. 3). The base 16 of the dish 12 extends across an opening 26 at the lower end of the open volume 24 of the rim 14. The upper portion 28 of the rim wall 22 terminates in a flange 30. At the ends of the rim 14 are provided projecting handles 32 for moving the tray 10 during use.

In operation, a stack of dish members 12 may be placed bottom side up on a flat surface or in a specially designed holder adjacent to a food preparation area, or the like. To assemble the tray 10, a rim 14 is inverted and placed over the stack of dish members 12. A slightly downward pressure is applied on the rim 14. The pressure causes the upper-most dish 12 and the rim 14 to engage by means of a retaining member 32. It is contemplated that the tray 10, formed from assembled dish 12 and rim 14 could be lifted off the stack and flipped over to the normal upright position. Thereafter, food may be provided in the interior of the tray and the tray placed within a warming oven or the like.

As illustrated in FIG. 3, the retaining member comprises an inwardly projecting ridge 34 positioned on the inner surface of the lower portion 26 of the rim wall 22. Preferably, the ridge 34 extends around a substantial portion of the rim wall 22. A correspondingly positioned retaining groove 36 is formed on the lower regions of the dish 12. The retaining groove 36 is formed in the sidewall 18 of the dish 12 and is preferably continuous around the outer periphery of the sidewall. The projecting ridge 34 forms a frictional engagement with the retaining groove 36, releaseably retaining the dish 12 within the rim 14.

The base 16 of the dish 12 is positioned below the projecting ridge 34. In a preferred embodiment, the base 16 is positioned vertically above the lowest edge of the rim wall 22, such that the base is spaced from any planar surface upon which the tray 10 rests when in the normal upright position. The application of pressure to the rim 14 to secure the dish 12 thereto creates a “snap” together type action or friction fit.

Other variations of a retaining member are contemplated. For example, the inwardly projecting ridge 34 could be replaced by a outwardly projecting ridge on the dish. Thus, the outwardly projecting ridge would engage the inner surface of the rim sidewall to form the frictional fit. In addition, the friction fit may secure the positioning of the dish within the rim by engagement of the rim flange 30 with the peripheral flange 20 on the dish 12. Additional frictional engagement between the inner wall of the rim wall and the sidewall of the dish may also be included in the formation for removeably securing the dish to the rim.

Other combinations of elements are contemplated and may include, for example, windows in the lower portion of the rim that would accept outwardly projecting bumps or detents on the dish or any combination of these feature. Preferably, there is a “snap” action which brings the two parts together and frictionally secures the two parts during use. It is contemplated that the frictional fit will be sufficient to retain the dish therein while permitting removal of the dish portion from the rim with an ordinary removal force.

It is contemplated that the materials of the rim will be relatively sturdy whereas the dish may be a more flexible material. In the preferred embodiment, the dish portion is considered to be disposable. Thus, it is contemplated that the dish will not be subject to cleaning but rather it will be tossed out after use and replaced by a new dish. Thus, the first material for constructing the dish is contemplated to be a different material than that contemplated for constructing the rim.

It is preferable that both the dish and the rim be constructed of a plastic material of a type generally adapted to be used in the temperature and variable humidity conditions of a food preparation and warming oven, without corrosion, deformation or reaction with surrounding materials. It is preferable that the materials and construction used meet the NSF guidelines for food service devices. Again, it is preferred that the dish have a relatively inexpensive, light weight form so as to be disposable after a few usages.

A variety of modifications to the embodiments described will be apparent to those skilled in the art from the disclosure provided herein. Thus, the invention may be embodied in other specific forms without departing from the spirit or essential attributes thereof and, accordingly, reference should be made to the appended claims, rather than to the foregoing specification, as indicating the scope of the invention.

What is claimed is:

1. A tray for handling food in a warming oven comprising:
a dish, constructed from a first material, having
a base portion adapted for handling of food products, and
a sidewall portion surrounding the base portion and extending upwardly therefrom, the sidewall portion and base portion defining a retaining area, having a closed end formed by the base portion and an open end disposed away from the base portion at the upper end of the sidewall; and
a rim, constructed from a second material, having
rim wall extending generally parallel to the sidewall of the dish and removeably positioned around the perimeter of the dish,
a retaining member formed on the rim for mating engagement with the sidewall portion of the dish and removeably retaining the dish in a fixed position with respect to the rim portion.

2. The tray according to claim 1, wherein the first material is a light weight plastic.

3. The tray according to claim 2, wherein the second material is a relatively rigid plastic material, different from the first material.

4. The tray according to claim 1, wherein the rim further comprises a first end and a second end disposed longitudinally away from the first end, each of the first and second ends having a projecting handle.

5. The tray according to claim 1, wherein the dish comprises at least one flange extending around the periphery of the sidewall at the upper end of the side wall.

6. The tray according to claim 5, wherein the rim includes a rim flange surrounding the rim wall, the dish flange engaging the flange on the dish.

7. The tray according to claim 1, wherein the retaining member comprises an inwardly projecting ridge on the rim wall adapted to frictionally engage a retaining groove formed in the sidewall of the dish.

8. The tray according to claim 1, wherein the engagement between the dish and the rim by the retaining member comprises a friction fit.

9. The tray according to claim 1, wherein the rim defines an opening at its lower end, adjacent the base of the dish.

10. A tray comprising:
a dish portion having
a base, and
a sidewall surrounding the base and extending upwardly therefrom, the sidewall defining an open end opposite from the base portion, the sidewall and the base defining a retaining volume; and
a rim supporting the dish, the rim having
a rim wall extending generally parallel to the sidewall portion of the dish, and
a flange formed on the rim wall; and
a retaining member for engaging the sidewall of the dish portion to the rim wall and removeably securing the rim to the dish.

11. The tray according to claim 10, wherein the dish is made from a first material and the rim in made from a second, different material.

12. The tray according to claim 10, wherein the dish further comprises a projecting flange extending outwardly from the sidewall, adjacent the open end, and wherein the projecting flange engages the rim flange.

13. The tray according to claim 10, wherein the retaining member is formed at least in part on the rim wall and engages the side wall of the dish.

14. The tray according to claim 13, wherein the retaining member further comprises a projecting ridge inwardly projecting from the rim wall and engaging the sidewall.

15. The tray according to claim 14, wherein the projecting ridge of the retaining member engages a retaining groove formed in the sidewall of the dish.
